(19) United States
(12) Patent Application Publication
(10) Pub. No.: US 2020/0408176 A1
(43) Pub. Date: Dec. 31, 2020

(54) ACCESS CAPS

(71) Applicant: SONUS Engineered Solutions, Warren, MI (US)

(72) Inventors: Pal Molnar, Grosse Pointe Woods, MI (US); Tim Droege, Macomb, MI (US)

(21) Appl. No.: 16/908,948

(22) Filed: Jun. 23, 2020

Related U.S. Application Data
(60) Provisional application No. 62/867,517, filed on Jun. 27, 2019.

(51) Int. Cl. F02M 35/08; B65D 47/20; B65D 47/12

(52) U.S. Cl. CPC F02M 35/08; B65D 47/12; B65D 47/2031

(57) ABSTRACT

An access cap includes a body portion, a handle at a first end of the body portion, and a flexible spout at a second end of the body portion. The handle and the flexible spout extend from the body portion in opposite directions.

### CROSS-REFERENCE TO RELATED APPLICATION

This application claims priority to U.S. Provisional Application No. 62/867,517, which was filed on Jun. 27, 2019.

### BACKGROUND

Vehicle components may acquire debris, such as sand, dirt, dust, snow/ice etc., or other undesirable materials.

### SUMMARY

An access cap according to an example of this disclosure includes a body portion, a handle at a first end of the body portion, and a flexible spout at a second end of the body portion. The handle and the flexible spout extend from the body portion in opposite directions.

In a further example of the foregoing, the flexible spout has a duckbill shape.

In a further example of any of the foregoing, the flexible spout includes an opening.

In a further example of any of the foregoing, the opening includes a length and a width, and the length is greater than the width.

In a further example of any of the foregoing, the flexible spout includes rubber.

In a further example of any of the foregoing, a locking mechanism is configured to secure the access cap to a component.

In a further example of any of the foregoing, the locking mechanism includes a plurality of circumferentially spaced tension members.

In a further example of any of the foregoing, the body portion includes at least one step.

A vehicle component according to an example of this disclosure includes an opening. An access cap is received in the opening. The access cap includes a body portion, a handle at a first end of the body portion, and a flexible spout at a second end of the body portion. The handle and the flexible spout extend from the body portion in opposite directions.

In a further example of the foregoing, the flexible spout has a duckbill shape.

In a further example of any of the foregoing, the flexible spout includes rubber.

In a further example of any of the foregoing, the flexible spout includes an opening.

In a further example of any of the foregoing, a locking mechanism is configured to secure the access cap to the component.

In a further example of any of the foregoing, the locking mechanism includes a plurality of circumferentially spaced tension members, and the opening provides a plurality of circumferentially spaced slots, and the plurality of circumferentially spaced tension members are configured to be received in the plurality of circumferentially spaced slots.

In a further example of any of the foregoing, the opening is provided by a lower panel of an engine airbox.

An access cap according to an example of this disclosure includes a hollow body portion, which includes at least one step. A handle is at a first end of the body portion, and a flexible spout comprised of rubber and has a duckbill shape at a second end of the body portion. The flexible spout provides an opening having a length and a width. The length is greater than the width, and the handle and the flexible spout extend from the body portion in opposite directions.

These and other features may be best understood from the following specification and drawings, the following of which is a brief description.

### BRIEF DESCRIPTION OF THE DRAWINGS

FIG. 1 shows an example engine air supply system.

FIG. 2 shows an example access cap opening in an example airbox.

FIG. 3 shows an isometric view of an example access cap.

FIG. 4 shows a side view of the example access cap of FIG. 3.

FIG. 5 shows a view from the bottom on the example access cap of FIGS. 3-4.

### DETAILED DESCRIPTION

This disclosure relates generally to access caps for accessing any vehicle component for the removal of debris or other undesirable materials. Although the particular examples disclosed are related to an engine air supply system, and more particularly an engine airbox, other vehicle components may benefit from this disclosure, including ducts, lines, or chambers for air conditioning, cooling, fuel, break, transmission, or other systems in the vehicle. The component may be a component of any vehicle, including a military vehicle in some examples. Other vehicles, such as automobiles, heavy trucks, agricultural vehicles, commercial vehicles, as well as water and air vehicles, may benefit from this disclosure.

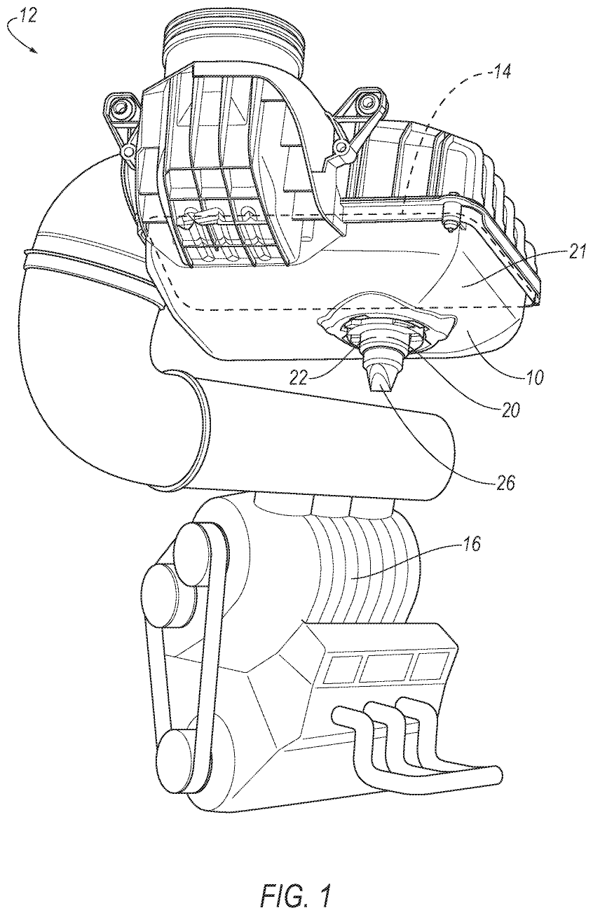

FIG. 1 schematically illustrates an example engine airbox 10 in an engine air supply system 12. The engine airbox 10 houses one or more air filters 14, shown schematically. The engine airbox 10 draws air from outside of the engine through the one or more air filters 14 and to the engine 16 for combustion. The air collected by the airbox 10 can include debris, such as sand, dirt, dust, snow/ice etc. An access cap 20 is provided at the engine airbox 10 to provide access to the airbox 10 for removing debris. In the example shown, the access cap 20 is provided at a lower panel 21 with respect to the orientation shown in FIG. 1. This orientation may be the normal orientation for operation of the vehicle, such that gravity allows debris to fall to the flexible spout 26 for removal, discussed further below. As shown, the flexible spout 26 protrudes outward of the airbox 10.

Some engine airboxes include particle separators, while others are the particle separators themselves, which have a particular geometry and orientation configured to separate particles from any flow (in this case, airflow). Removing particles/debris from the engine airbox 10 improves the lifetime of the engine 16 and other components of the engine air supply system 12, such as the air filters 14 inside the airbox 10 in some examples.

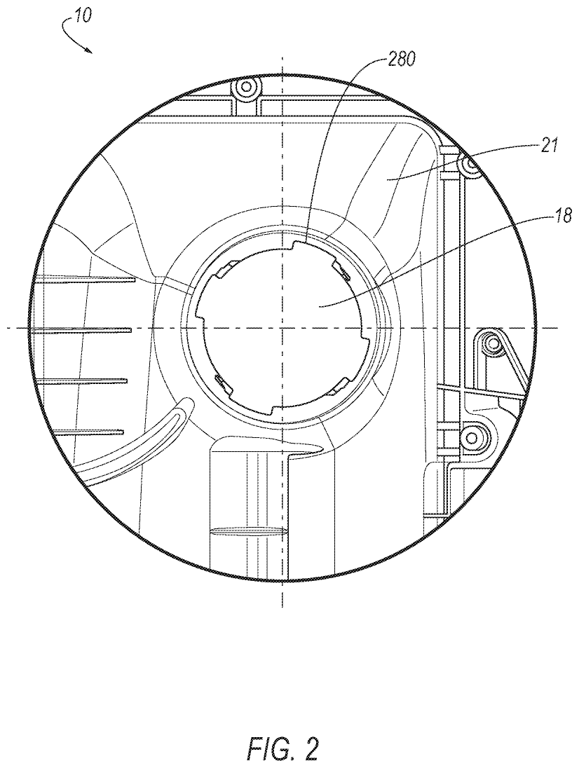

FIG. 2 shows a portion of the example airbox 10 with an opening 18 for receiving the access cap 20. As shown, in some examples, the opening 18 includes one or more circumferentially spaced slots 280 (discussed further below) around its outer perimeter. Although four slots 280 are shown in the illustrative example, more or fewer slots 280 may be utilized. In some examples, as shown in FIGS. 1 and 2, the opening 18 is provided in the lower panel 21.

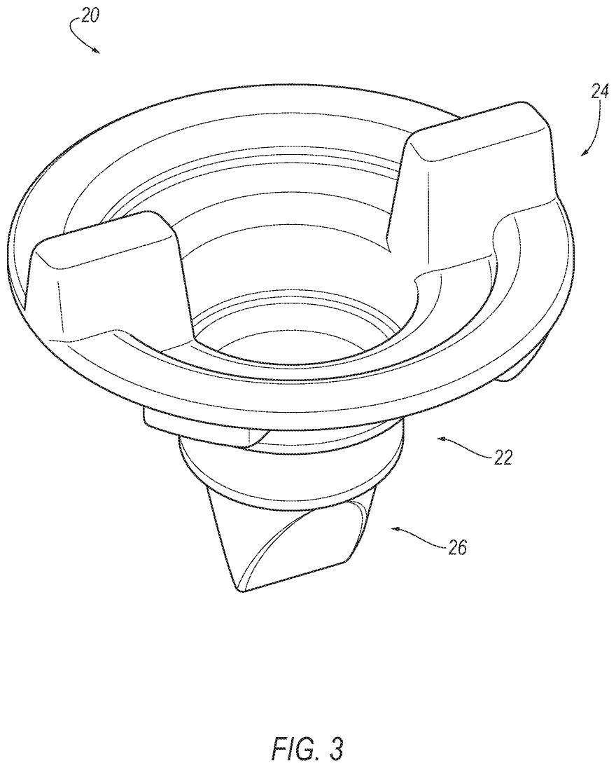

As shown in FIG. 3, the access cap 20 generally includes a body portion 22 with a handle 24 at a first end of the body portion 22 and one or more flexible spouts 26 at a second end of the body portion 22. Though FIGS. 3-5 show a single flexible spout 26, it should be understood that other example access caps 20 can include more than one flexible spout 26. With reference to FIG. 2, the body portion 22 and flexible spout 26 are received in the opening 18 of the engine airbox 10. In some examples, as shown, the handle 24 and flexible spout 26 extend out from the body portion 22 in opposite directions.

In an example, the body portion 22 is generally conical. As shown in FIG. 3, in some examples, the body portion 22 is hollow.

With reference back to FIG. 1, the body portion 22 may protrude outward of the airbox 10. The handle 24 may be provided for securing the access cap 20 from within the airbox 10 in some examples.

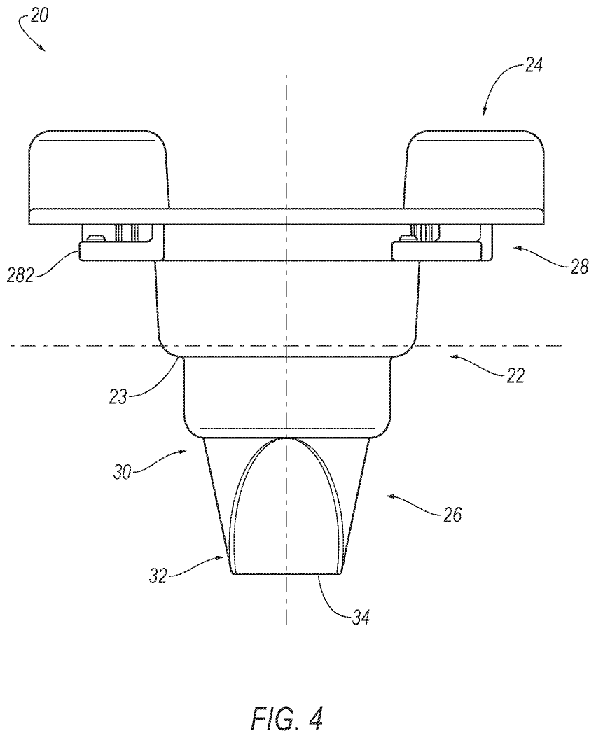

As shown in FIG. 4, in some examples, the body portion 22 can include one or more steps 23 along its length. The example access cap 20 includes a locking mechanism 28 that can be actuated by the handle 24 for securing the access cap 20 to the airbox 10. In some examples, the locking mechanism 28 is configured for twisting engagement of the access cap 20 with the airbox 10, as is described in U.S. Pat. No. 8,596,483, which is fully incorporated herein by reference. Specifically, with reference back to FIG. 2, the opening 18 may include slots 280 that are configured to engage with members 282 of the locking mechanism 28. In a particular example, the members 282 are tension members. Tension members have a spring-like capacity to engage with a mating surface of slots 280 (not shown) for locking the access cap 20 when the access cap 20 is twisted into place in the opening 18.

The flexible spout 26 may be made of any flexible material, such as rubber in some examples. In some examples, the flexible spout 26 is molded as a single-piece with the body portion 22. The flexible spout 26 has a duckbill-shaped design. In general, the duckbill shaped design has an open base 30 which is adjacent the body portion 22 and tapers to a flattened portion 32 as best seen in FIG. 3.

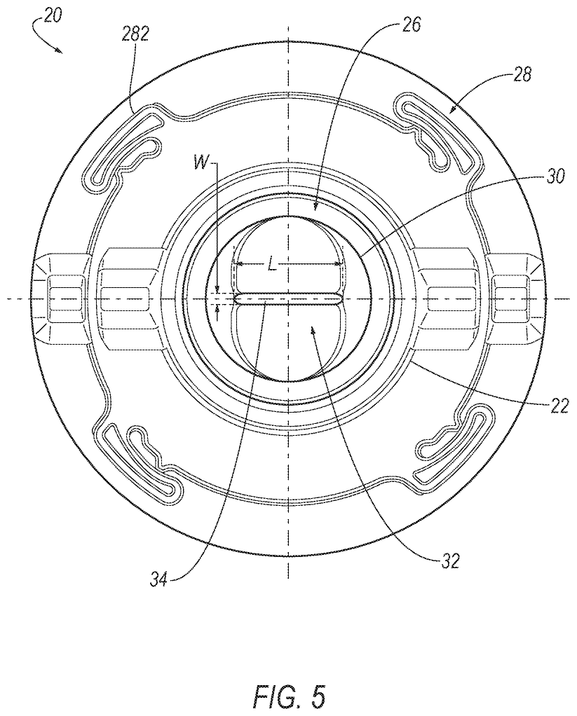

As shown in FIG. 5, the flattened portion 32 has as long, narrow opening 34. That is, the opening 34 has length L several orders of magnitude higher than a width W.

In the examples involving an engine airbox 10, when the engine is running, the engine airbox is under vacuum as it draws air from outside the vehicle. During these vacuum conditions, the flexible spout 26 remains sealed. In other words, the narrow opening 34 is tightly closed. Therefore, hot air from other parts of the engine is prevented from entering the airbox. Effective sealing of the airbox improves the efficiency and performance of the engine because it helps keep the air in the airbox cool prior to the air being provided to the engine. Because the flexible spout 26 is sealed when the engine is running (e.g., under vacuum conditions), other sealing means associated with the access cap 20 are not necessary. Accordingly, the access cap 20 is a single-piece component that provides effective sealing while also being removable to provide access to the airbox for removal of debris. In examples where the airbox includes a particle separator, the particle separator can be configured to collect particles/debris near the access cap 20. Particles/debris can also build up in the filter in the airbox (discussed above) or in other parts of the airbox. When the engine is turned off, the vacuum in the airbox is released, and the opening 34 is no longer tightly closed. Therefore, particles/debris can exit the airbox via the opening 34 when the opening 34 is not under vacuum. In a particular example, the access cap 20 is oriented such that the opening 34 faces downward, e.g., towards the ground, when installed in a vehicle. In this example, gravity aids removal of particles/debris from the airbox via the opening 34.

The opening 34 can be further expanded by applying inward pressure along the flexible spout 26 to remove particles/debris, such as by a pinching input applied at opposing long ends of the opening. Referring back to FIG. 1, the flexible spout is accessible from outside of the airbox 10 for such access. To remove large debris/particles or in instances where a lot of debris/particles build up in the airbox 10, the access cap 20 can also be fully removed from the airbox 10 for access to the airbox 10 and/or cleaning, for example. Though some of the foregoing description is made with respect to an airbox 10, it should be understood that the access cap 20 can also be used in other vehicle components, as discussed above.

Although the different examples are illustrated as having specific components, the examples of this disclosure are not limited to those particular combinations. It is possible to use some of the components or features from any of the embodiments in combination with features or components from any of the other embodiments.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. An access cap, comprising:
a body portion;
a handle at a first end of the body portion; and
a flexible spout at a second end of the body portion, wherein the handle and the flexible spout extend from the body portion in opposite directions.

2. The access cap of claim 1, wherein the flexible spout has a duckbill shape.

3. The access cap of claim 2, wherein the flexible spout includes an opening.

4. The access cap of claim 3, wherein the opening includes a length and a width, and the length is greater than the width.

5. The access cap of claim 2, wherein the flexible spout comprises rubber.

6. The access cap of claim 1, further comprising a locking mechanism configured to secure the access cap to a component.

7. The access cap of claim 6, wherein the locking mechanism comprises a plurality of circumferentially spaced tension members.

8. The access cap of claim 1, wherein the body portion includes at least one step.

9. A vehicle component, comprising:
an opening;
an access cap received in the opening, the access cap including a body portion, a handle at a first end of the body portion, and a flexible spout at a second end of the body portion, wherein the handle and the flexible spout extend from the body portion in opposite directions.

10. The component of claim 9, wherein the flexible spout has a duckbill shape.

11. The component of claim 10, wherein the flexible spout comprises rubber.

12. The component of claim 10, wherein the flexible spout includes an opening.

13. The component of claim 9, further comprising a locking mechanism configured to secure the access cap to the component.

14. The component of claim 13, wherein the locking mechanism comprises a plurality of circumferentially spaced tension members, and the opening provides a plurality of circumferentially spaced slots, and the plurality of circumferentially spaced tension members are configured to be received in the plurality of circumferentially spaced slots.

15. The component of claim 9, wherein the opening is provided by a lower panel of an engine airbox.

16. An access cap, comprising:
a hollow body portion including at least one step;
a handle at a first end of the body portion; and
a flexible spout comprising rubber and having a duckbill shape at a second end of the body portion, the flexible spout providing an opening having a length and a width, wherein the length is greater than the width, and the handle and the flexible spout extend from the body portion in opposite directions.
